(19) United States
(12) Patent Application Publication
(10) Pub. No.: US 2015/0106171 A1
(43) Pub. Date: Apr. 16, 2015

(54) DYNAMIC PRICING BASED ON SLIDING MODE CONTROL AND ESTIMATION FOR HIGH OCCUPANCY TOLL LANES

(71) Applicant: Xerox Corporation, Norwalk, CT (US)

(72) Inventors: Guangyu Zou, Webster, NY (US); Lina Fu, Fairport, NY (US); Rakesh S. Kulkarni, Webster, NY (US)

(73) Assignee: Xerox Corporation, Norwalk, CT (US)

(21) Appl. No.: 14/051,927

(22) Filed: Oct. 11, 2013

(51) Int. Cl. G06Q 30/02; G06Q 50/30

(52) U.S. Cl. CPC G06Q 30/0283; G06Q 50/30
USPC 705/13

(57) ABSTRACT

Methods and systems for dynamic pricing based on sliding mode control with respect to a HOT (High Occupancy Toll) lane. The controller consists of a feed-forward path and a feedback path. In the feed-forward path, a sliding mode controller in association with a sliding mode control module can be configured to achieve desired performance objectives under time-varying system parameters in real-time. An estimated VOT (Value of Time) distribution can be derived in association with the controller to reduce the difference between an actual and target traffic flow density on the HOT lane. The estimation of the VOT distribution can be updated by the controller at each time interval when the difference in densities is larger than a certain threshold. A low pass filter can also be employed to substantially improve prediction and the calculation of tolls to reduce fluctuations in traffic.

### FIELD OF THE INVENTION

Embodiments generally relate to traffic management and HOT (High Occupancy Toll) lanes. Embodiments are also related to pricing schemes for minimizing traffic congestion. Embodiments are additionally related to dynamic pricing algorithms based on sliding mode control with respect to HOT lanes.

### BACKGROUND

Traffic congestion is a condition on a road network that occurs as use increases and is characterized by slower speeds, longer trip times, and increased vehicular queueing. Several travel demand management techniques have been attempted to alleviate traffic congestion. For example, HOV (High occupancy vehicle) lanes have been employed to encourage people to share rides and thus decrease the amount of vehicles on the roads. HOT (High occupancy toll) lanes allow high occupancy vehicles to travel for free and low occupancy vehicles to use the lanes for a fee when there is capacity. HOT lanes increase the utilization of HOV lanes and some dynamic pricing algorithms can also help to manage peak hour traffic demands.

HOT lanes can be implemented in the context of a road pricing scheme that provides motorists in a low occupancy vehicle access to a HOV (High Occupancy Vehicle) lane. Tolls can be collected either by a manned toll booth, automatic number plate recognition, or an electronic toll collection system. Typically, these tolls increase as traffic flow density and congestion within the tolled lanes increases, a policy known as congestion pricing. The goal of this pricing scheme includes but not limited to minimize traffic congestion within the lanes, to maximize throughput, and to maximize revenue. The pricing scheme in HOT lanes can be implemented utilizing a static approach or a dynamic approach. The prices can be defined based on time of the day in the static approach. Such an approach, however, cannot maintain a level of service in the HOT lanes (e.g., average speed, throughput, etc.) since it does not dynamically adjust the HOT toll rate in real-time.

With the advent of electronic toll collection systems, pricing can also be accomplished dynamically so that the tolls can be set in real-time depending on the traffic conditions. The majority of prior art dynamic pricing algorithms are reactive in nature and do not account for potential demand for actual future time interval that the toll is determined for. Reactive controllers often determine the pricing with respect to the difference between desired values of metrics and the actual values in the HOT lanes. Due to the distance between the location to detect traffic and the location of toll booth, it has a delay to respond the emerging traffic in a timely manner. Also, due to lack of prediction, they can often result in fluctuations. Such fluctuations can be especially significant when there are time delays or traffic jams present in the HOT lanes. The HOT system is highly nonlinear and complex in nature. Therefore, more sophisticated designs are required for HOT pricing control.

There are prior arts where prediction of future system state is considered in the toll pricing. However, impractical assumptions are involved and thus making them inapplicable to current HOT lane management systems. For example, in one prior art approach a future interval can be predicted with a two-step pricing mechanism. The desired incoming traffic volume with respect to the HOT lanes can be determined based on the feedback of the average speed in the HOT and GP lanes. Then the toll rate can be calculated from an estimation of the total upstream demand, assuming known and fixed value of time (VOT) distribution for the drivers. The assumption, however, is not practical.

In another prior art approach a rolling-horizon optimization can be employed to determine the toll price, which relies on a multi-lane traffic flow model, demand forecast, and VOT estimation. Such approach assumes a Logit choice model and utilizes Kalman Filter to learn the distribution and to address the problem of unknown VOT. However, the learning mechanism requires detectors right before and after the HOT/GP split and assumes all incoming vehicles are potential payers, which is not necessarily true. Such an approach is also difficult to implement and is essentially feed-forward only and cannot account for the prediction error.

Based on the foregoing, it is believed that a need exists for an improved method and system for providing a dynamic pricing algorithm based on sliding mode control and estimation for the HOT lanes, as will be described in greater detail herein.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved HOT (High Occupancy Toll) lane management method and system.

It is another aspect of the disclosed embodiments to provide for an improved dynamic pricing algorithm for HOT lanes.

It is a further aspect of the disclosed embodiments to provide for an improved method and system for providing a dynamic pricing algorithm based on sliding mode control and estimation of driver behavior for HOT lanes.

Another aspect of the disclosed embodiments is to provide an improved dynamic pricing algorithm for HOT lanes, which goal includes but not limited to maintaining the target traffic flow density, maintaining the target speed, maximizing throughput, and maximizing revenue.

The aforementioned aspects and other objectives and advantages can now be achieved as described herein. Methods and systems for dynamic pricing based on sliding mode control and estimation for a HOT lane are disclosed herein. A pricing controller consisting of a feed-forward path and a feedback path, where the former configured with a sliding mode control module, can be designed to achieve performance objectives under time-varying system parameter in real-time. An estimated value of time (VOT) distribution can be configured in association with the sliding mode control module to reduce difference between an actual and target traffic flow density on the HOT lane. The module can update the estimation of the VOT distribution at each time interval when the difference in densities is larger than a certain threshold. A low pass filter can also be configured to substantially improve the prediction. Based on the VOT estimate, the pricing controller can calculate the tolls in the feed-forward and feedback paths, and combine them to achieve predefined targets that include but not limited to reduce fluctuations in traffic, to maintain a service level, and to maximize utilization of HOT lanes. Such an approach substantially improves the prediction and ultimately achieves the goal of the HOT lane pricing in an optimal manner.

In general sliding mode control practice, a sliding surface can be selected to drive the controller dynamics towards the surface utilizing a discontinuous control input. For the methods and systems disclosed here, the sliding surface can be defined as the difference between the actual and target densities. The estimated value of time distribution can be configured in association with the feed-forward path of the pricing controller to achieve an optimization objective of the HOT lanes and contribute to a study of driver choice behavior in terms of the value of time distribution. The driver's decision to enter the HOT lane can be determined by a behavior model, such as utility functions, for the HOT and GP lane, respectively.

The utility function relates the utility for a driver to take the HOT lanes or the GP lanes as a function of a set of inputs including the toll price, the respective travel times on HOT and GP lanes, the drivers' value of time, and reliability of HOT and GP lanes. The vehicles can choose to take the HOT lanes if the ratio of the utility function for the HOT lanes and the utility function for the GP lanes is greater than a threshold. The determination of the threshold can be derived from survey data or conducted in the calibration process of building simulation. Without loss of generality, the threshold can be set to 1 so that the driver takes the HOT lane only if the utility function for the HOT lane is greater than the utility function for the GP lane.

The controller updates the estimation of the mean of the VOT distribution at each time interval and employs the estimated VOT distribution to determine the base toll price in order to drive the sliding surface towards zero. The average of the estimated value of time is an optimal value for the parameter to ensure the sliding surface is zero and can be obtained utilizing the low pass filter. The average value of time signal can be employed instead of value of time in the pricing controller to further reduce oscillation. The average value of time signal can be viewed as an approximation of mean of the actual VOT distribution and the value can be utilized to improve the operation of the pricing controller as well as to guide the pricing design of toll facilities. The results can also assist researchers and government agencies to gain insights on the driver choice behavior, for example, on the variation through different hours of the day, between weekdays and weekends, and on seasonal changes.

The sliding mode based dynamic pricing controller is able to adapt to time varying, difficult-to-predict system parameters and inputs so that the controller response is fast to real-time changes and maintains a steady, maximal traffic flow. The controller can be easily implemented for existing and new HOT lane facilities, without extensive detailed prior research on potential demand and VOT distribution. Also, the system self-adapts to changes over time without the need of a technical specialist to periodically examine and manually adjust the control parameters. The controller can also reveal important messages with respect to a travel demand and driver behavior, including a key parameter and a trend over time.

### BRIEF DESCRIPTION OF THE FIGURES

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system, in accordance with the disclosed embodiments;

FIG. 2 illustrates a schematic view of a software system including a dynamic pricing module, an operating system, and a user interface, in accordance with the disclosed embodiments;

FIG. 3 illustrates a block diagram of a dynamic pricing system based on a sliding mode control and estimation for a high occupancy toll lane, in accordance with the disclosed embodiments;

FIG. 4 illustrates a high level flow chart of operations illustrating logical operational steps of a method for providing a dynamic pricing algorithm based on sliding mode control and estimation for a HOT lane, in accordance with the disclosed embodiments;

FIG. 5 illustrates a schematic block diagram of a dynamic pricing controller based on sliding mode control, in accordance with the disclosed embodiments;

FIG. 6 illustrates a schematic block diagram of a feed forward path associated with the dynamic pricing controller, in accordance with the disclosed embodiments; and

FIG. 7 illustrates a schematic block diagram of a feedback path associated with the dynamic pricing controller, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the present invention can be embodied as a method, data processing system, or computer program product. Accordingly, the present invention may take the form of an entire hardware embodiment, an entire software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages such as the “C” programming language or in a visually oriented programming environment such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

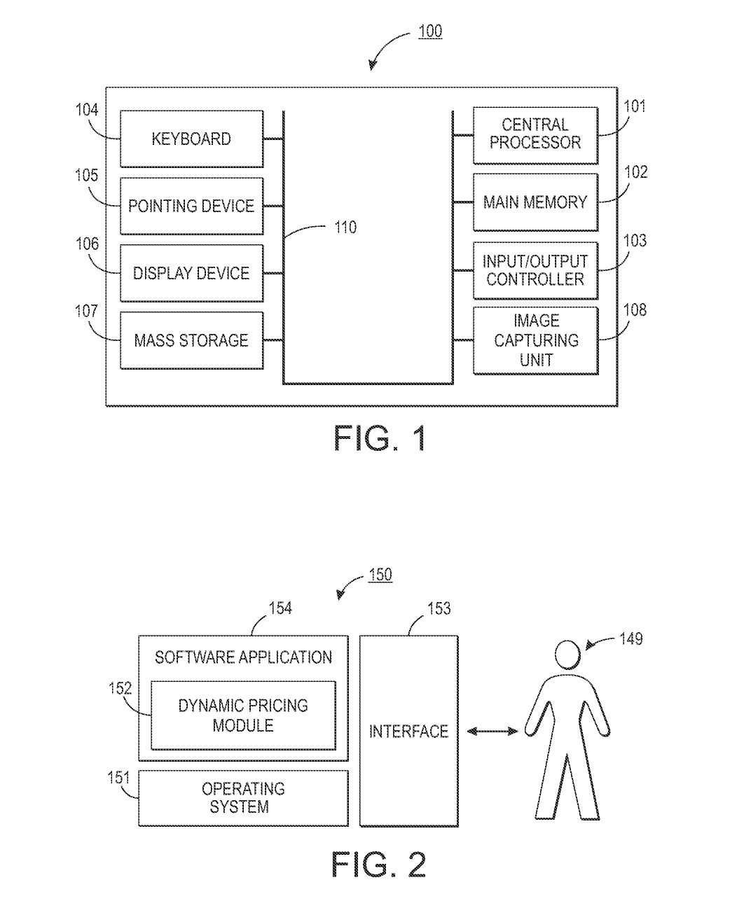

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a system bus 110, a central processor 101, a main memory 102, an input/output controller 103, a keyboard 104, an input device 105 (e.g., a pointing device such as a mouse, track ball, and pen device, etc.), a display device 106, a mass storage 107 (e.g., a hard disk), and an image capturing unit 108. In some embodiments, for example, a USB peripheral connection (not shown in FIG. 1) and/or other hardward components may also be in electrical communication with the system bus 110 and components thereof. As illustrated, the various components of data-processing system 100 can communicate electronically through the system bus 110 or a similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 151 and/or software application 154.

The following discussion is intended to provide a brief, general description of suitable computing environments in which the system and method may be implemented. Although not required, the disclosed embodiments will be described in the general context of computer-executable instructions such as program modules being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application such as a computer program designed to assist in the performance of a specific task such as word processing, accounting, inventory management, etc.

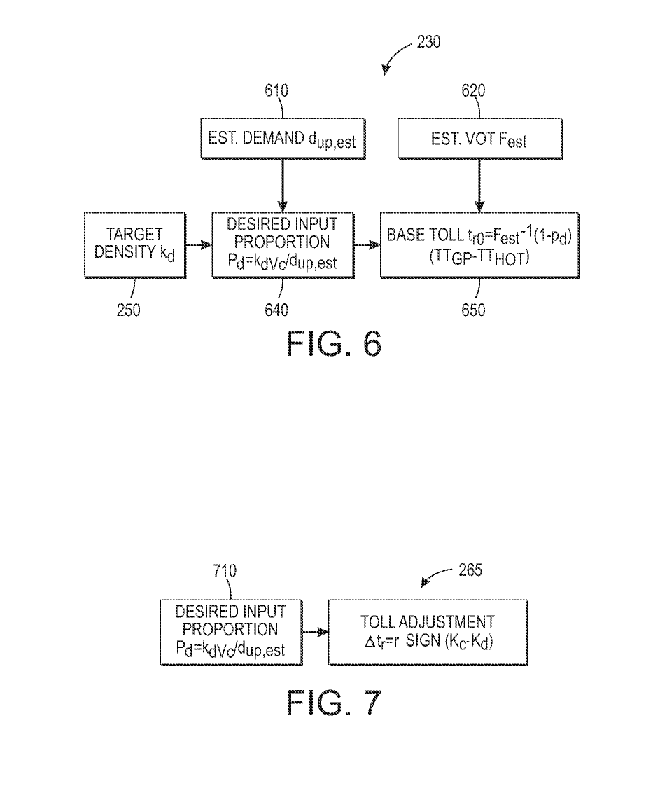

The interface 153, which is preferably a graphical user interface (GUI), also serves to display results, whereupon the user may supply additional inputs or terminate the session. In an embodiment, operating system 151 and interface 153 can be implemented in the context of a “Windows” system. It can be appreciated, of course, that other types of systems are possible. For example, rather than a traditional “Windows” system, other operation systems such as, for example, Linux may also be employed with respect to operating system 151 and interface 153. The software application 154 can include a dynamic pricing module 152 for providing a dynamic pricing algorithm based on sliding mode control and estimation for a HOT lane. Software application 154, on the other hand, can include instructions such as the various operations described herein with respect to the various components and modules described herein such as, for example, the methods 600 and 700 depicted in FIGS. 6-7.

FIGS. 1-2 are thus intended as examples and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms including Macintosh, UNIX, LINUX, and the like.

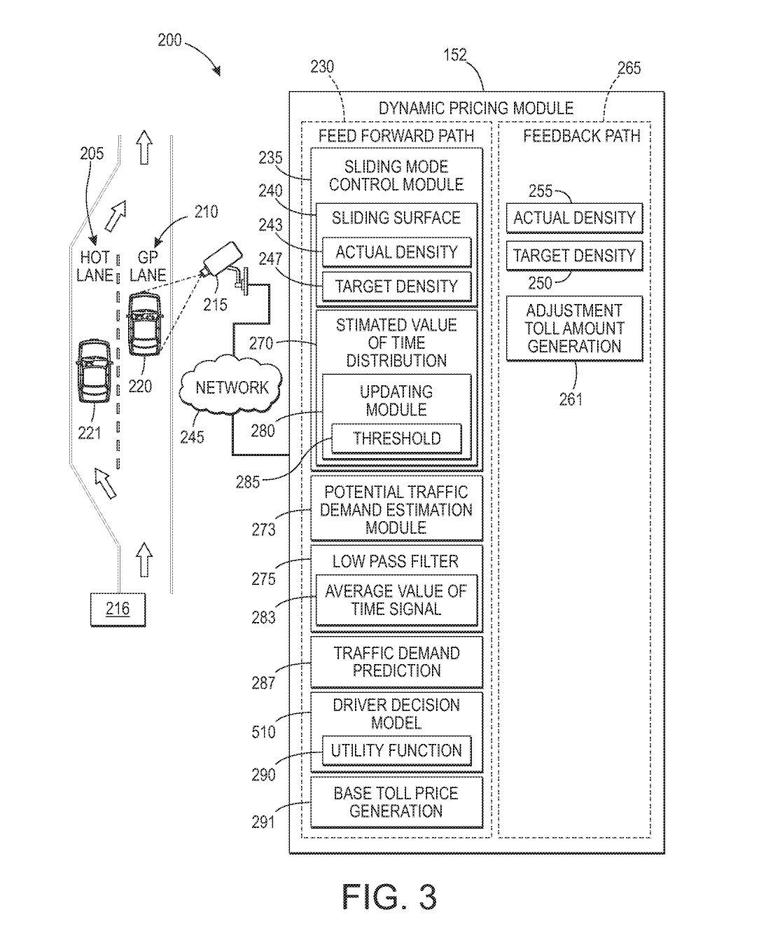

FIG. 3 illustrates a block diagram of a dynamic pricing system 200 based on a sliding mode control and estimation for a high occupancy toll lane 205, in accordance with the disclosed embodiments. Note that in FIGS. 1-8, identical or similar blocks are generally indicated by identical reference numerals. The toll lane can be, for example, the HOT (High Occupancy Toll) lane 205 and/or a general purpose lane 210. As shown in the example of FIG. 3, a vehicle 220 is shown in the GP lane 210 and a vehilde 221 is shown in the HOT lane 205. HOT lanes 205 require low-occupant vehicles to pay a toll that varies based on demand, called congestion pricing. The tolls change throughout the day according to real-time traffic conditions, which is intended to manage the number of vehicles in the lanes for desired performance objectives such as to maintain a minimum speed and/or to maximize the utilization of HOT lanes.

The dynamic pricing system 200 generally includes one or more detection devices 215 such as, for example, an image capturing unit 108 (e.g., camera), sensor, loop detectors, etc., for sensing and capturing the speed, flow rate of the traffic flow, and/or an image of a vehicle 220 within an effective field of view. The detection device 215 can be operatively connected to the dynamic pricing module 152 via a network 245. The image capturing unit 108 may include built-in integrated functions such as image processing, data formatting, and data compression functions.

The dynamic pricing system 200 generally also includes one or more variable message signs 216 located before the entry of the toll lanes to display real time toll price to the drivers. The message sign may also display the time saving if drivers take HOT lanes than take GP lanes. The variable message signs 216 can be operatively connected to the dynamic pricing module 152 via a network 245.

Note that the network 245 may employ any network topology, transmission medium, or network protocol. The network 245 may include connections such as wire, wireless communication links, or fiber optic cables. Network 245 can also be an Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational, and other computer systems that route data and messages. It can be appreciated that network 245 may also be another type of network such as, for example, a cellular telephone network (e.g., CDMA, TDMA, GSM, PSC, etc.), and/or the Internet. In other cases, network 245 may be, for example, a WLAN (Wireless Local Area Network), etc.

The dynamic pricing module 152 can be configured to include a feed forward path 230 and a feedback path 265. The feed forward path 230 can be configured to further include a sliding mode control module 235 to adapt to time-varying system parameter in real-time. In general, the sliding mode control module 235 relates to the concept of a sliding surface 240. The surface 240 is a subspace in the state space of the system, where the system dynamics have desired properties and behaviors. After such surface 240 is selected, the control objective is to drive the system dynamics towards the surface 240 utilizing discontinuous control input. The equivalent control, which can be approximated by the time-average of the discontinuous control input, is also helpful in estimating system variables and disturbances. The slide mode control module 235 includes the sliding surface 240 (e.g., sliding surface data) including actual HOT lane traffic flow density data 243 and target HOT lane traffic flow density data 247.

An estimated value of time (VOT) distribution module 270 can be configured in association with the sliding mode control module 235 to reduce the difference between respective actual and target traffic densities 255 and 250 on the HOT lane 205. The estimated value of time (VOT) distribution module 270 further includes an updating module 280 to update the value of time estimation 270 at each time interval when the difference in densities is larger than a certain threshold 285. A low pass filter 260 can also be configured to obtain a smoother estimation of value of time via an average value of time signal 283, substantially improve the prediction, and tolls can be calculated to reduce fluctuations in traffic and to maintain a service level. The driver's behavior model 510 on their decision of whether to enter the HOT lane 205 or not can be determined by a utility function 290 for HOT and GP lane 205 and 210 respectively.

The feed forward path 230 of the dynamic pricing module 152 also includes a potential traffic demand estimation module 273 which estimates the total potential traffic demand in terms of vehicle counts for the next time interval for the HOT lanes. Based on the estimated value of time distribution module 270, the potential traffic demand estimation module 273 and the driver behavior module 510, the Base toll price generation module 291 generates a base toll price so that the predicted number of vehicles entering the HOT lanes 205 in the next time interval matches the desired number as dictated by the target traffic flow density in the HOT lanes 205.

The feedback path 265 includes an adjustment toll amount generation module 261, which generates an adjustment amount to the base toll price from base toll price generation module 291 in the feed forward path 230. The adjustment amount is determined by the difference between the actual traffic flow density and the target traffic flow density in the HOT lanes 205.

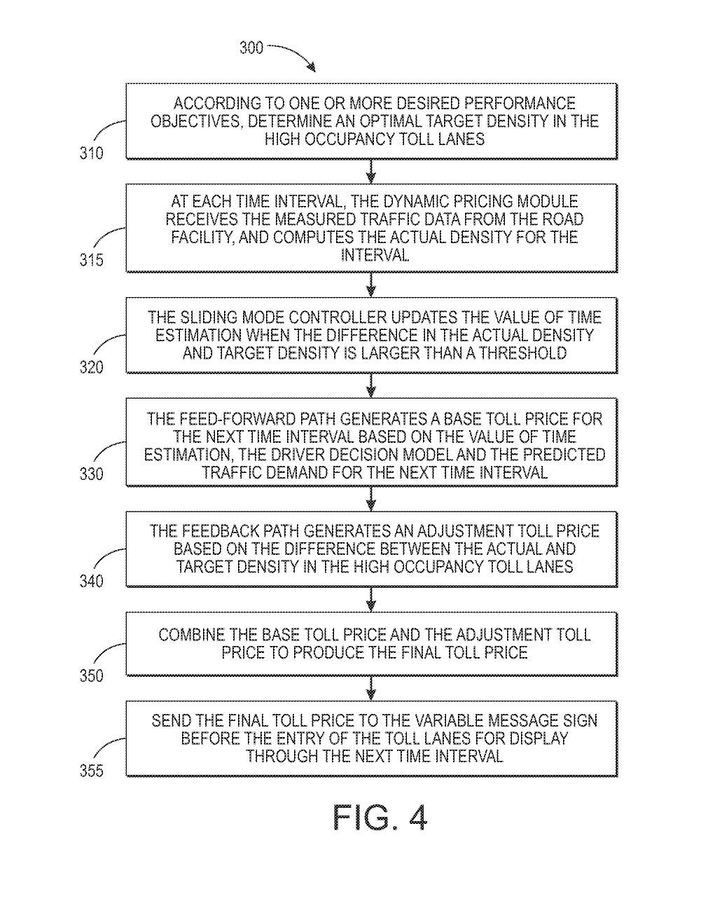

FIG. 4 illustrates a high level flow chart of operations illustrating logical operational steps of a method 300 for providing dynamic pricing algorithm of HOT lanes 205 based on sliding mode control and estimation, in accordance with the disclosed embodiments. It can be appreciated that the logical operational steps shown in FIG. 4 can be implemented or provided via, for example, a module such as module 154 shown in FIG. 2 and can be processed via a processor such as, for example, the processor 101 shown in FIG. 1. Initially, the optimal target traffic flow density 247 for the HOT lanes 205 can be determined by the system administrator according to one or more performance objectives, as indicated at block 310.

At each time interval, as depicted at block 315, the dynamic pricing module 152 can receive the measured traffic data from sensors 215 located along, for example, a road facility, and computes the actual traffic flow density of the HOT lanes 205 for the time interval. Then, in the feed-forward path 230, the sliding mode controller 235 as shown at block 320, updates the value of time estimation 270 when the difference in the actual traffic flow density and target traffic flow density is larger than a threshold. Then, as indicated at block 330, based on the value of time estimation 270, the driver decision model 510, and the predicted traffic demand 287 for the next time interval, a base toll price is generated for the next time interval based on the target traffic flow density.

In the meantime, as shown at block 340, the feedback path 265 generates an adjustment toll price based on the difference between the actual and target traffic flow density in the high occupancy toll lanes 205. Finally, the base toll price and the adjustment toll price are combined as indicated at block 350 to produce the final toll price. The final price can then be transmitted via network 245 as described at block 355 to the variable message signs located before the entry of the HOT lanes and displayed there to notify the drivers of the incoming vehicles.

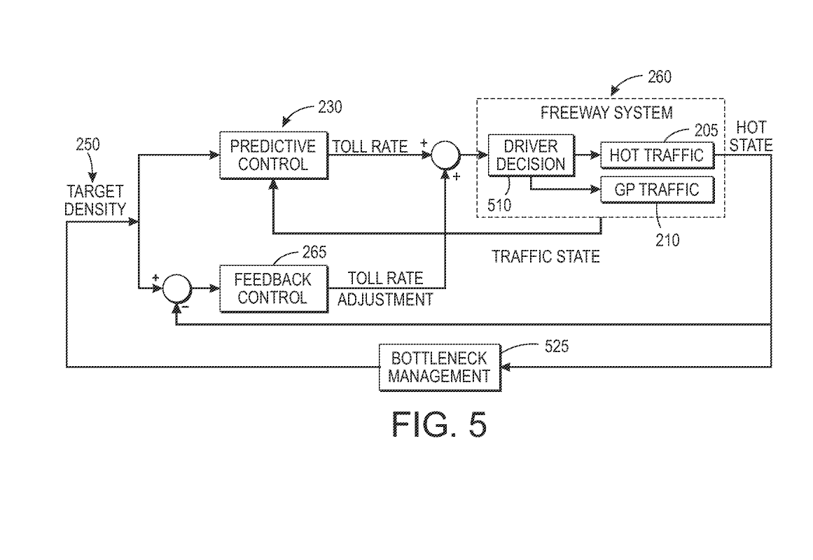

FIG. 5 illustrates a schematic block diagram of the sliding mode based dynamic pricing controller 152, in accordance with the disclosed embodiments. The controller 152 includes the feed-forward path 230 and the feedback path 265 to regulate the traffic flow density at the target level. The target flow density 250 can be determined to achieve maximal throughput while maintaining required Level of Service (LOS). The feed-forward path 230 enables the use of predictions and estimations based on existing data to improve performance of the HOT lane 205. The feedback path 265 compensates for the prediction/estimation error so that the desired performance is achieved. The controller 152 regulates the traffic flow density at the first detector location of the HOT segment 205 to address the variable time delay and infinite dimensionality of the traffic flow, in the pricing system. In the meantime, the bottleneck management module 525 monitors all detectors in the segment, and adjusts the target traffic flow density 250 accordingly when a bottleneck emerges. In this way the required LOS can be maintained through the HOT segment 205.

FIGS. 6-7 illustrate a schematic block diagram of the feed forward path 230 and the feedback path 265 associated with the dynamic pricing controller 152, in accordance with the disclosed embodiments. The feed-forward path 230 is based on traffic demand prediction 610 and estimation of the value of time (VOT) 620 distribution of the incoming drivers. The demand prediction can be derived from survey data, user data, historical and real time detector measurements, as well as real time weather and events information. The toll 650 can be calculated based on a desired input proportion 640, estimated demand 610 and estimated value of time 620.

The feed-forward path 230 of the controller 152 predicts future system inputs and states, in order to generate the baseline toll for the next time interval, so that the target traffic flow density 250 can be achieved. The predictive path permits the controller 260 to react faster to foreseeable or detected changes. The feedback path 265 is incorporated to compensate for the prediction error 710 and ensure the desired performance can be achieved.

As an example embodiment, the sliding surface 240 can be defined as the difference between the actual and target densities 255 and 250 as shown below in equation (1):

s=k_{c}−k_{d} (1)

The variable k_{c} represents the actual traffic flow density, and the variable k_{d} represents the target traffic flow density. The goal of the sliding mode control module 235 is now reformulated so as to drive s towards zero. For the feed forward path 230, a simple VOT model with a uniform distribution on [θ−σ, θ+σ] can be employed. The cumulative distribution of VOT with respect to the toll tᵣ is given by equation (2).

$${F}_{est} ( {t}_{r} ) = \{ \begin{matrix}0 , & {t}_{r} < θ - σ \\ \frac{{t}_{r} - θ + σ}{2 σ} , & θ - σ \leq {t}_{r} \leq θ + σ \\ 1 , & {t}_{r} > θ + σ\end{matrix} \qquad ( 2 )$$

The parameter θ represents an estimate of the mean of the actual VOT distribution. The value of σ represents level of variation of the distribution. The driver's decision 510 whether or not to enter the HOT lane 205 can be determined by the utility functions for HOT and GP lane 205 and 210 respectively. The utility function 290 for HOT and GP can be calculated as shown below in equation (3).

$${U}_{HOT} = \frac{1}{θ \times {TT}_{HOT} + TR} \\ {U}_{GP} = \frac{1}{θ \times {TT}_{GP}} \\ {P}_{HOT} = \frac{{U}_{HOT}}{{U}_{GP}} = \frac{\frac{1}{θ \times {TT}_{HOT} + TR}}{\frac{1}{θ \times {TT}_{GP}}} = \frac{{TT}_{GP}}{{TT}_{HOT} + \frac{TR}{θ}} \qquad ( 3 )$$

The variables TT_{HOT} and TT_{GP} represent the travelling time on the HOT and GP lanes respectively. The variable TR represents the toll rate and θ represents the value of time of a specific driver. P_{HOT} represents the ratio of U_{HOT} to U_{GP}. Only if P^{HOT} is greater than a threshold, the driver choose to enter the HOT lane 205. The determination of the threshold 285 can be obtained through survey data, or conducted in the calibration process of building simulation. Without loss of generality, the threshold 285 can be set to be 1, which means that the driver takes the HOT lane 205 only if the U_{HOT}>U_{GP}. Given TT_{HOT}, TT_{GP} and TR, P_{HOT} increases with θ. In other words, the demand for HOT is positive correlated to the θ. Thus, if k_{c}>k_{d}, the θ estimation is lower than its actual value, it is necessary to increase the θ estimation. On the other hand, if k_{c}<k_{d}, the θ estimation needs to be decreased, which in turn results in lower tolls so that more vehicles 220 are encouraged to enter the HOT lane 205.

Based on the above analysis, with the objective of driving s towards zero, the sliding mode control module 235 updates its estimation of the mean of the VOT distribution at each time interval as illustrated below in equation (4):

$${θ}_{k + 1} = \{ \begin{matrix}{θ}_{k} + ɛ , & s > δ \\ {θ}_{k} , & - δ \leq s \leq δ \\ {θ}_{k} - ɛ , & s < - δ\end{matrix} , where ɛ , δ > 0 \qquad ( 4 )$$

The estimated VOT distribution can be employed to determine the base toll tᵣ₀. Here the value of ε is the step size for updating θ. The value of δ represents the tolerance window for the deviation of s from zero. It helps to reduce the oscillation in the system from constantly changing the value of θ. According to the equivalent control theory, the value of θ averaged over time is the optimal value for the parameter to ensure s=0. The low pass filter 255 can be used to obtain the average of a signal θₐᵥ as indicated in equation (5) as follows:

τ\grave{θ}ₐᵥ+1=θ,τ<<1, (5)

The discrete form can be calculated as shown in equation (6):

θ_{av,k+1}=αθ_{av,k}+(1−α)θₖ,0<α<1 (6)

To further reduce oscillation, the average signal θₐᵥ can be employed instead of θ in the pricing controller 152. In scenarios where the demand forecast is generally good, θₐᵥ can be viewed as an approximation of mean of the actual VOT distribution, which is difficult to measure directly. The value can be used to improve the operation of the pricing controller 152 as well as guide the pricing design of toll facilities elsewhere. The results can also help the researchers and government agencies to gain insights on driver choice behavior, for example, on the variation through different hours of the day, between weekdays and weekends, and on seasonal changes.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A sliding mode based dynamic pricing method for a high occupancy toll lane, said method comprising:
determining an optimal target traffic flow density with respect to at least one high occupancy toll lane to achieve one or more desired performance objectives;
designing a pricing controller that includes a feed-forward path and a feedback path, wherein said feed-forward path is configured with a sliding mode controller in association with a sliding mode control module to update in real-time an estimated value of time of drivers;
configuring said sliding mode controller to update said estimated value of time to reduce a difference between an actual traffic flow density and the said target traffic flow density with respect to said at least one high occupancy toll lane, such that said estimated value of time is updated at each time interval when said difference in said actual traffic flow density and said target traffic flow density is larger than a particular threshold;
generating a base toll price from said feed-forward path based on said estimated value of time, a driver decision model and an estimated potential traffic demand so that an estimated number of vehicles entering said at least one high occupancy toll lane in a next time interval will match said target traffic flow density;
generating an adjustment toll price from said feedback path based on said difference between said actual traffic flow density and said target traffic flow density with respect to said at least one high occupancy toll lane to reduce said difference, wherein said base toll price and said adjustment toll price are combined to produce a final toll price.

2. The method of claim 1 further comprising configuring a low pass filter in said sliding mode controller to obtain a smoother estimation of value of time and to reduce fluctuation in traffic with respect to said at least one high occupancy toll lane.

3. The method of claim 2 further comprising:
selecting a sliding surface and a discontinuous input to change said estimated value of time to drive dynamics of said controller towards said sliding surface wherein said sliding surface represents a desired system state.

4. The method of claim 4 further comprising permitting said discontinuous input to increase or decrease said estimated value of time upon a deviation from said sliding surface.

5. The method of claim 1 further comprising using said estimated value of time to provide information for a study of time-varying driver choice behavior in terms of a distribution associated with said estimated value of time.

6. The method of claim 1 further comprising:
determining a driver decision model wherein a driver decides to enter said at least one high occupancy toll lane by a utility function with respect to said at least one high occupancy toll lane and at least one general purpose lane respectively based on said estimated value of time and said toll price;
selecting said at least one high occupancy toll lane by said driver if a ratio of said utility function for said at least one high occupancy toll lane to said utility function for said at least one general purpose lane is greater than a particular threshold.

7. The method of claim 3 further comprising:
obtaining an average value of time distribution signal by said low pass filter; and
updating an estimate of said average value of time distribution signal at each time interval; and
utilizing said estimate of said average value of time distribution signal to determine said base toll price in order to drive said sliding surface towards zero.

8. The method of claim 7 further comprising configuring said average value of time distribution signal in association with sliding mode feedback to further reduce oscillation.

9. A sliding mode based dynamic pricing system for a high occupancy toll lane, said system comprising:
a processor; and
a computer-usable medium embodying computer program code, said computer-usable medium capable of communicating with the processor, said computer program code comprising instructions executable by said processor and configured for:
determining an optimal target traffic flow density with respect to at least one high occupancy toll lane to achieve one or more desired performance objectives;
designing a pricing controller that includes a feed-forward path and a feedback path, wherein said feed-forward path is configured with a sliding mode controller in association with a sliding mode control module to update in real-time an estimated value of time of drivers;
configuring said sliding mode controller to update said estimated value of time to reduce a difference between an actual traffic flow density and the said target traffic flow density with respect to said at least one high occupancy toll lane, such that said estimated value of time is updated at each time interval when said difference in said actual traffic flow density and said target traffic flow density is larger than a particular threshold;
generating a base toll price from said feed-forward path based on said estimated value of time, a driver decision model and an estimated potential traffic demand so that an estimated number of vehicles entering said at least one high occupancy toll lane in a next time interval will match said target traffic flow density;
generating an adjustment toll price from said feedback path based on said difference between said actual traffic flow density and said target traffic flow density with respect to said at least one high occupancy toll lane to reduce said difference, wherein said base toll price and said adjustment toll price are combined to produce a final toll price.

10. The system of claim 9 further comprising a low pass filter located in said sliding mode controller to obtain a smoother estimation of value of time and to reduce fluctuation in traffic with respect to said at least one high occupancy toll lane.

11. The system of claim 10 wherein said instructions are further configured for selecting a sliding surface and a discontinuous input to change said estimated value of time to drive dynamics of said controller towards said sliding surface wherein said sliding surface represents a desired system state.

12. The system of claim 11 wherein said instructions are further configured for permitting said discontinuous input to increase or decrease said estimated value of time upon a deviation from said sliding surface.

13. The system of claim 9 wherein said instructions are further configured for employing said estimated value of time to provide information for a study of time-varying driver choice behavior in terms of a distribution associated with said estimated value of time.

14. The system of claim 9 wherein said instructions are further configured for:
determining a driver decision model wherein a driver decides to enter said at least one high occupancy toll lane by a utility function with respect to said at least one high occupancy toll lane and at least one general purpose lane respectively based on said estimated value of time and said toll price; and
selecting said at least one high occupancy toll lane by said driver if a ratio of said utility function for said at least one high occupancy toll lane to said utility function for said at least one general purpose lane is greater than a particular threshold.

15. The system of claim 11 wherein said instructions are further configured for
obtaining an average value of time distribution signal by said low pass filter
updating an estimate of said average value of time distribution signal at each time interval; and
utilizing said estimate of said average value of time distribution signal to determine said base toll price in order to drive said sliding surface towards zero.

16. A processor-readable medium storing code representing instructions to cause a process for sliding mode based dynamic pricing for a high occupancy toll lane, said code comprising code to:
determine an optimal target traffic flow density with respect to at least one high occupancy toll lane to achieve one or more desired performance objectives;
design a pricing controller that includes a feed-forward path and a feedback path, wherein said feed-forward path is configured with a sliding mode controller in association with a sliding mode control module to update in real-time an estimated value of time of drivers;
configure said sliding mode controller to update said estimated value of time to reduce a difference between an actual traffic flow density and a target traffic flow density with respect to said at least one high occupancy toll lane, such that said estimated value of time is updated at each time interval when said difference in said actual traffic flow density and said target traffic flow density is larger than a particular threshold;
generate a base toll price from said feed-forward path based on said estimated value of time, a driver decision model and an estimated potential traffic demand so that an estimated number of vehicles entering said at least one high occupancy toll lane in a next time interval will match said target traffic flow density; and
generate an adjustment toll price from said feedback path based on said difference between said actual traffic flow density and said target traffic flow density with respect to said at least one high occupancy toll lane to reduce said difference, wherein said base toll price and said adjustment toll price are combined to produce a final toll price.

17. The processor-readable medium of claim 16 further comprising a low pass filter in said sliding mode controller to obtain a smoother estimation of value of time and to reduce fluctuation in traffic with respect to said at least one high occupancy toll lane.

18. The processor-readable medium of claim 17 wherein said code further comprises code to select a sliding surface and a discontinuous input to change said estimated value of time to drive dynamics of said controller towards said sliding surface wherein said sliding surface represents a desired system state.

19. The processor-readable medium of claim 16 wherein said code further comprises code to employ said estimated value of time to provide information for a study of time-varying driver choice behavior in terms of a distribution associated with said estimated value of time.

20. The processor-readable medium of claim 16 wherein said code further comprises code to:
determine a driver decision model wherein a driver decides to enter said at least one high occupancy toll lane by a utility function with respect to said at least one high occupancy toll lane and at least one general purpose lane respectively based on said estimated value of time and said toll price; and
select said at least one high occupancy toll lane by said driver if a ratio of said utility function for said at least one high occupancy toll lane to said utility function for said at least one general purpose lane is greater than a particular threshold.
